(19) United States
(12) Patent Application Publication
(10) Pub. No.: US 2026/0010360 A1
(43) Pub. Date: Jan. 8, 2026

(54) ROBOT CONTROL SYSTEM, CONTROL DEVICE, COMPUTER PROGRAM, AND UPDATE PROCESSING METHOD FOR CONTROL SOFTWARE

(71) Applicant: Fanuc Corporation, Minamitsuru-gun, Yamanashi (JP)

(72) Inventors: Tomoyuki YAMAMOTO, Minamitsuru-gun, Yamanashi (JP); Keita MAEDA, Minamitsuru-gun, Yamanashi (JP); Shunichi OZAKI, Minamitsuru-gun, Yamanashi (JP)

(73) Assignee: Fanuc Corporation, Minamitsuru-gun, Yamanashi (JP)

(21) Appl. No.: 18/881,407

(22) PCT Filed: Sep. 9, 2022
(86) PCT No.: PCT/JP2022/033947

§ 371 Date: Jan. 6, 2025

(51) Int. Cl. G06F 8/65

(52) U.S. Cl. CPC G06F 8/65

(57) ABSTRACT

The present invention comprises a control device that is for a robot, a base member that is connected to the control device by wired communication, and a mobile communication terminal that can be attached to or detached from the base member and can wirelessly communicate with an external device, wherein: when the mobile communication terminal is detached from the base member and the wired communication is canceled, update control software is downloaded to the mobile communication terminal from an external server; and when the mobile communication terminal is attached to the base member and is connected to the base member by wired communication, control software for the control device is updated by the downloaded update control software.

### CROSS REFERENCE TO RELATED APPLICATIONS

This is the U.S. National Phase application of PCT/JP2022/033947, filed Sep. 9, 2022, the disclosure of this application being incorporated herein by reference in its entirety for all purposes.

### FIELD OF THE INVENTION

The present disclosure relates to a robot control system, a controller, a computer program, and an update processing method for control software.

### BACKGROUND OF THE INVENTION

A plant provided with a robot control system lacks an environment for accessing the Internet, such as Wi-Fi (registered trademark). Therefore, when control software of a controller of an industrial machine, such as a robot, is updated, new updating control software is temporarily stored in a portable storage medium, such as a memory card or a USB memory, and software update processing is performed by connecting the portable storage medium to the controller.

For example, a robot system including: a transmitting-side robot controller transmitting updating software; and a receiving-side robot controller receiving the updating software from the transmitting-side robot controller, wherein each of the transmitting-side robot controller and the receiving-side robot controller includes: a first storage unit configured to store a software update processing program and robot motion control software; a second storage unit configured to store the software update processing program read from the first storage unit; a third storage unit configured to store the updating software; and a communication unit configured to transmit and receive the updating software stored in the third storage unit is known (for example, see PTL 1).

For example, Paragraph in PTL 2 describes “Each program may be provided by being recorded on a computer-readable recording medium, such as a CD-ROM, an FD, a CD-R, a DVD, or a USB memory, as a file in an installable format or an executable format. The program may be introduced by being stored in a storage unit in a computer connected to a communication network and being downloaded through the network.”

### PATENT LITERATURE

[PTL 1] WO 2010/089951A1

[PTL 2] JP2020-075340A

### SUMMARY OF THE INVENTION

In general, operation of portable storage media, such as a memory card and a USB memory, is confirmed for major equipment such as a Windows (registered trademark) terminal, an Android (registered trademark) terminal, and an iOS (registered trademark) terminal. However, for special equipment, such as a controller in a robot control system, operation of portable storage media is not confirmed, and operation guarantee may not be provided. Accordingly, it is desired to provide a robot control system and a computer program that can easily update control software.

According to an aspect of the present disclosure, a robot control system includes: a controller of a robot; a base member connected to the controller through a wired communication; and a mobile communication terminal being attachable and detachable to and from the base member, being able to wirelessly communicate with an external device, and instructing the controller about a motion of the robot, based on a teaching operation content, when being attached to the base member and being connected to the base member through a wired communication, wherein updating control software is downloaded from an external server being the external device to the mobile communication terminal when the mobile communication terminal is removed from the base member and a wired communication with the base member is released, and control software of the controller is updated with the downloaded updating control software when the mobile communication terminal is attached to the base member and is connected to the base member through a wired communication.

According to an aspect of the present disclosure, a computer program for causing a computer to execute update processing of control software of a controller of a robot in a robot control system including: a base member connected to the controller; and a mobile communication terminal being attachable and detachable to and from the base member and instructing the controller about a motion of the robot, based on a teaching operation content, includes: a download step of downloading updating control software from an external server being an external device to the mobile communication terminal when the mobile communication terminal is removed from the base member and a wired communication with the base member is released; and an update step of updating control software of the controller with the updating control software downloaded in the download step when the mobile communication terminal is attached to the base member and is connected to the base member through a wired communication.

According to an aspect of the present disclosure, an update processing method for control software of a controller of a robot in a robot control system including: a base member connected to the controller; and a mobile communication terminal being attachable and detachable to and from the base member and instructing the controller about a motion of the robot, based on a teaching operation content, includes: a download step of downloading updating control software from an external server being an external device to the mobile communication terminal when the mobile communication terminal is removed from the base member and a wired communication with the base member is released; and an update step of updating control software of the controller with the updating control software downloaded in the download step when the mobile communication terminal is attached to the base member and is connected to the base member through a wired communication.

According to an aspect of the present disclosure, a controller equipped with control software for controlling an industrial machine includes: at least one memory; and at least one processor, wherein the at least one processor accepts a connection to a base member, accepts a connection to a mobile communication terminal attachable and detachable to and from the base member or a connection to the mobile communication terminal through a connection to the base member, acquires updating control software from the mobile communication terminal and stores the updating control software into the at least one memory after accepting connections to the base member and the mobile communication terminal, and updates the control software with the updating control software stored in the at least one memory.

### BRIEF DESCRIPTION OF DRAWINGS

FIG. 1 is a block diagram illustrating a robot control system according to an embodiment of the present disclosure.

FIG. 2 is a diagram illustrating a schematic appearance of the robot control system according to the embodiment of the present disclosure.

FIG. 3 is a diagram illustrating a download method with a first configuration in the robot control system according to the embodiment of the present disclosure.

FIG. 4 is a diagram illustrating a download method with a second configuration in the robot control system according to the embodiment of the present disclosure.

FIG. 5 is a diagram illustrating communication protocols between a mobile communication terminal and a controller in the robot control system according to the embodiment of the present disclosure.

FIG. 6 is a flowchart illustrating an overall flow of update processing of control software of the controller in the robot control system according to the embodiment of the present disclosure.

FIG. 7 is a flowchart illustrating a detailed operation flow of the update processing of control software of the controller in the robot control system according to the embodiment of the present disclosure.

### DETAILED DESCRIPTION OF EMBODIMENTS OF THE INVENTION

A robot control system and a computer program according to an embodiment will be described below with reference to drawings. In the following description, components with the same or similar functions are given the same sign. Thus, redundant descriptions of the components may be omitted. “Updating control software” in the following description means the latest version of control software of a controller of a robot.

### Overall Configuration of Robot Control System

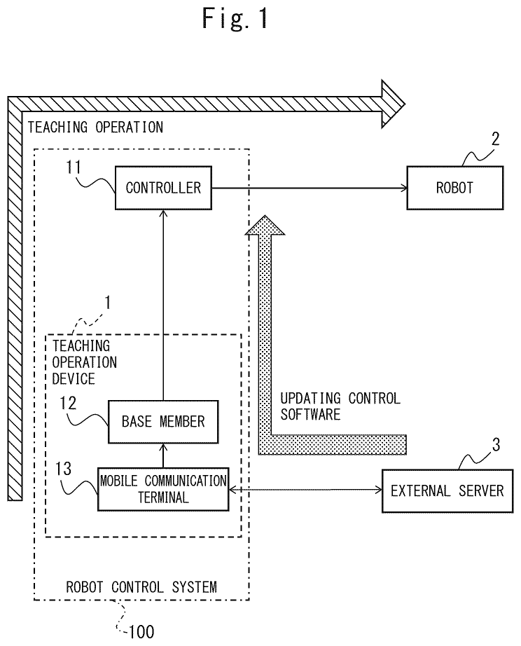

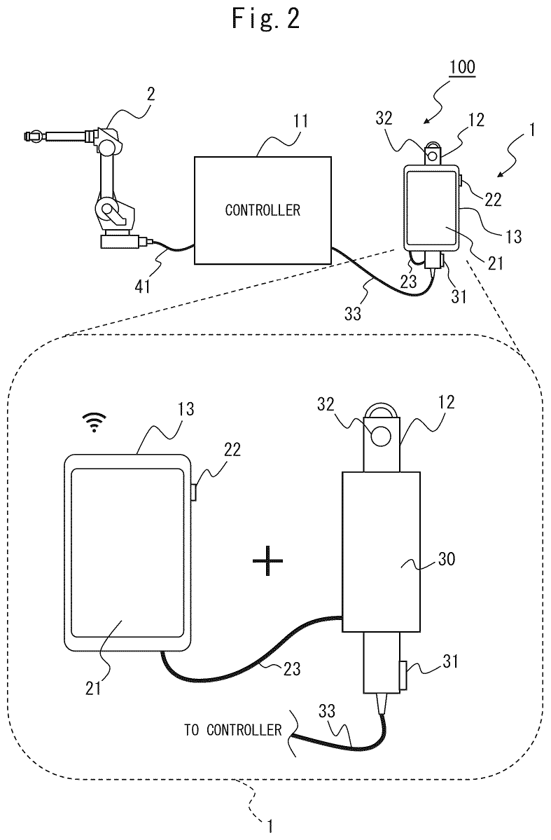

FIG. 1 is a block diagram illustrating the robot control system according to the embodiment of the present disclosure. FIG. 2 is a diagram illustrating a schematic appearance of the robot control system according to the embodiment of the present disclosure.

The robot control system 100 includes a controller 11, a base member 12, and a general-purpose mobile communication terminal 13.

A robot 2 being an industrial machine is connected to the controller 11 in a wired-communication-enabled manner through a cable 41 (hereinafter described as a “robot cable 41”). The motion of the robot 2 is controlled by the controller 11. The controller 11 is not directly connected to an external Internet line and therefore is not exposed to a threat on the Internet line. An arithmetic processing device (at least one processor) and a storage device (at least one memory) are provided in the controller 11. Examples of the arithmetic processing device include an IC, an LSI, a CPU, an MPU, and a DSP. Examples of the memory include electrically erasable/recordable nonvolatile memories, such as an EEPROM (registered trademark), and random-access memories capable of high-speed read/write, such as a DRAM and an SRAM. For example, the controller 11 including the arithmetic processing device is a function module provided by control software (a computer program) executed on a processor. By operating the arithmetic processing device in accordance with the control software, each type of processing in the controller 11 controlling the motion of the robot 2 can be provided.

The base member 12 is connected to the controller 11 through a wired communication and includes a communication interface (unillustrated) for the connection. The base member 12 is connected to the controller 11 in a wired-communication-enabled manner through a cable 33 (hereinafter described as a “teaching operation device cable 33”). The base member 12 includes an attachment base 30, and an enable switch 31 and an emergency stop button 32 as safety switches.

The attachment base 30 is used for attachably and detachably attaching the mobile communication terminal 13 to the base member 12. Examples of a method for attaching the mobile communication terminal 13 by the attachment base 30 include a method of gripping the mobile communication terminal 13 by sandwiching the mobile communication terminal 13 by a spring mechanism provided on the base member 12, a method of securing the mobile communication terminal 13 by screws, and a method of affixing the mobile communication terminal 13 by using an affixing member. The mobile communication terminal 13 physically attached through the attachment base 30 is connected to the base member 12 in a wired-communication-enabled manner through a cable 23 (hereinafter described as a “terminal cable 23”).

The enable switch 31 is a safety switch permitting control of the motion of the robot 2 by the controller 11 through the mobile communication terminal 13 while continuing to be depressed (turned on) and prohibiting control of the motion of the robot 2 by the controller 11 through the mobile communication terminal 13 by release of the depressed (turned-on) state. A signal based on an operation content for the enable switch 31 is transmitted from the base member 12 to the controller 11 through the teaching operation device cable 33. For example, the robot 2 does not move by any operation through the mobile communication terminal 13 while the enable switch 31 is not being depressed. An operation on the robot 2 through the mobile communication terminal 13 is enabled while the enable switch 31 is being depressed.

The emergency stop button 32 is a safety switch for instructing the controller 11 to cause the robot 2 to make an emergency stop. When the emergency stop button 32 is depressed (turned on), an emergency stop signal is transmitted from the base member 12 to the controller 11 through the teaching operation device cable 33, and the robot 2 makes an emergency stop in response. The mobile communication terminal 13 is a general-purpose portable information communication terminal that can wirelessly communicate with an external device. Examples of the mobile communication terminal 13 include a tablet terminal (tablet PC) and a smartphone. For example, the mobile communication terminal 13 includes a touch panel 21 having functions of both screen display and input operation acceptance. The mobile communication terminal 13 also includes a power button 22 for turning on the power to the mobile communication terminal 13. The mobile communication terminal 13 starts by the power button 22 being depressed (turned on) once. Further, the mobile communication terminal 13 internally includes a battery (unillustrated).

Since the mobile communication terminal 13 is a general-purpose information communication terminal, various types of application software can be installed on the terminal. One type of application software is teaching software for instructing the controller 11 about the motion of the robot 2, based on a teaching operation content.

The mobile communication terminal 13 is connected to the base member 12 in a wired-communication-enabled manner through the terminal cable 23 and includes a communication interface (unillustrated) for the connection. When the mobile communication terminal 13 installed with teaching software is attached to the base member 12 and is connected to the base member 12 through a wired communication, a teaching operation device 1 including the mobile communication terminal 13 and the base member 12 is constituted. When a teaching operation is performed by the mobile communication terminal 13 in the teaching operation device 1, the mobile communication terminal 13 is connected to the controller 11 in a wired-communication-enabled manner through the base member 12 and therefore can stably perform a teaching operation on the robot 2. When a worker operates the mobile communication terminal 13 in the teaching operation device 1, the mobile communication terminal 13 instructs the controller 11 about the motion of the robot 2, based on a teaching operation content. A storage unit (unillustrated) inside the mobile communication terminal 13 is installed with teaching software performing registration and editing of an operation program related to the robot 2, condition setting, state display, teaching of the robot 2, a manual operation, etc., and an arithmetic processing device similarly included inside the mobile communication terminal 13 provides a wireless teaching operation function of operating (teaching) the robot 2 by operating in accordance with the teaching software installed on the storage unit. Examples of the arithmetic processing device include an IC, an LSI, a CPU, an MPU, and a DSP. For example, the storage unit is configured with an electrically erasable/recordable nonvolatile memory, such as an EEPROM (registered trademark), or a random-access memory capable of high-speed read/write, such as a DRAM or an SRAM.

For example, the mobile communication terminal 13 is connected to an Internet line through a wireless LAN, such as Wi-Fi (registered trademark), or a mobile phone communication system (such as LTE, a 3G line, a 4G line, or a 5G line) and can perform data communication with an external device on the Internet line. The mobile communication terminal 13 may be connected to an Internet line through a cable, such as a USB cable (unillustrated) and perform data communication with an external device on the Internet line.

In order to secure efficiency and safety, control software of the controller 11 of the robot 2 is preferably always kept to the latest version in the robot control system 100. For example, “updating control software” being the latest version of the control software is stored in an external server 3 provided by a manufacturer or a distributor of the robot control system 100. The external server 3 is connected to an Internet line, and an operator of the robot control system 100 can acquire the updating control software by accessing the external server 3 from the mobile communication terminal 13 through the Internet line. The updating control software downloaded from the external server 3 to the mobile communication terminal 13 is temporarily stored into a storage unit in the mobile communication terminal 13.

According to the embodiment of the present disclosure, the control software of the controller 11 is not updated by using a portable storage medium, such as a memory card or a USB memory, as in the past. Accordingly, operation of a portable storage medium does not need to be confirmed beforehand even for special equipment, such as a controller in a robot control system. Since a portable storage medium is not used, when updating control software is downloaded, the download is not affected by the communication speed of a portable storage medium being a hardware device. Since the control software of the controller 11 is updated by using the general-purpose mobile communication terminal 13, a hardware device does not need to be newly added. In general, a plant provided with a robot control system often lacks an environment for accessing the Internet, such as Wi-Fi (registered trademark). The general-purpose mobile communication terminal 13 has a Wi-Fi (registered trademark) communication function for accessing the Internet, and it is easy to remove the mobile communication terminal 13 from the base member 12. Accordingly, it is easy to bring the mobile communication terminal 13 into an Internet-communication-enabled environment and download updating control software into the mobile communication terminal 13. Thus, the control software of the controller 11 according to the embodiment of the present disclosure can be easily updated.

According to the embodiment of the present disclosure, the mobile communication terminal 13 is disconnected from the controller 11, and updating software is downloaded from the external server 3 to the mobile communication terminal 13 in an Internet-connection-enabled environment; and then, the mobile communication terminal 13 is connected, in a wired manner, to the controller 11 not connected to an Internet line, and software update processing is performed. More specifically, updating control software is downloaded from the external server 3 being an external device to the mobile communication terminal 13 when the mobile communication terminal 13 is removed from the base member 12 and the wired communication between the mobile communication terminal 13 and the base member 12 is released. Then, the control software of the controller 11 is updated with the updating control software stored in the mobile communication terminal 13 when the mobile communication terminal 13 is attached to the base member 12 and the mobile communication terminal 13 is connected to the base member 12 through a wired communication.

According to the embodiment of the present disclosure, the at least one processor provided in the controller 11 accepts a connection to the base member 12. Further, the at least one processor provided in the controller 11 accepts a connection to the mobile communication terminal 13 attachable and detachable to and from the base member 12 or a connection to the mobile communication terminal 13 through a connection to the base member 12. After the at least one processor provided in the controller 11 accepts connections to the base member 12 and the mobile communication terminal 13, updating control software is acquired from the mobile communication terminal 13 and is stored into the at least one memory in the controller 11. The at least one processor provided in the controller 11 updates the control software with the updating control software stored in the at least one memory.

### Download of Updating Control Software

Several configurations for downloading updating control software to the mobile communication terminal 13 will be enumerated.

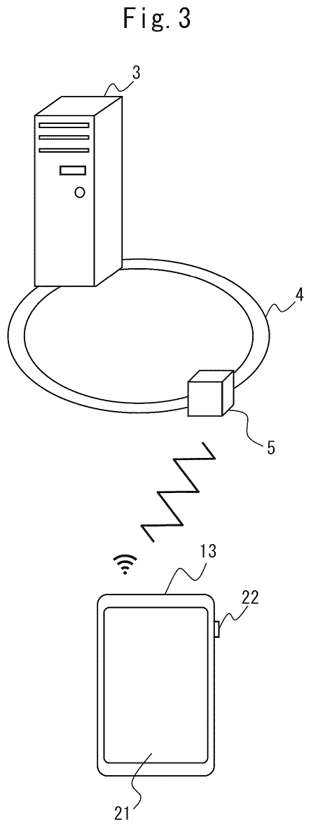

A download method with a first configuration is based on wireless communication. FIG. 3 is a diagram illustrating the download method with the first configuration in the robot control system according to the embodiment of the present disclosure. The external server 3 in which updating control software is stored is installed on an Internet line 4. For example, the Internet line 4 is connected to a router 5 configured with a Wi-Fi router (wireless LAN router). In the download method with the first configuration, the mobile communication terminal 13 is connected to the Internet line 4 through the router 5 when the mobile communication terminal 13 is removed from the base member 12 and the wired communication between the mobile communication terminal 13 and the base member 12 is released. Then, the updating control software is downloaded from the external server 3 on the Internet line 4 to the mobile communication terminal 13 through a wireless communication (Wi-Fi connection). The mobile communication terminal 13 may be connected to the Internet line 4 in a wireless-communication-enabled manner by a mobile phone communication system (such as LTE, a 3G line, a 4G line, or a 5G line) instead of the Wi-Fi connection.

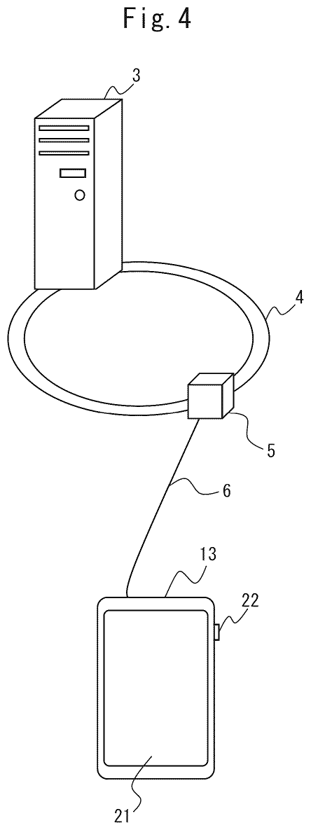

A download method with a second configuration is based on wired communication. FIG. 4 is a diagram illustrating the download method with the second configuration in the robot control system according to the embodiment of the present disclosure. The external server 3 in which updating control software is stored is installed on the Internet line 4. The Internet line 4 is connected to the router 5. In the download method with the second configuration, the mobile communication terminal 13 is connected to the Internet line 4 by connecting the mobile communication terminal 13 to the router 5 through a USB cable 6 when the mobile communication terminal 13 is removed from the base member 12 and the wired communication between the mobile communication terminal 13 and the base member 12 is released. Then, the updating control software is downloaded from the external server 3 on the Internet line 4 to the mobile communication terminal 13 through a wired communication.

### Software Update Processing

Software update processing is performed on the controller 11 when the mobile communication terminal 13 is attached to the base member 12 and the mobile communication terminal 13 is connected to the base member 12 through a wired communication after the updating control software is downloaded into the mobile communication terminal 13 as described above.

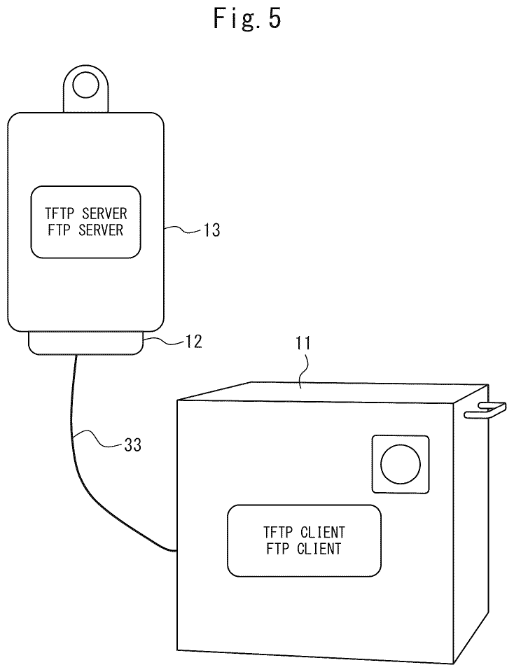

FIG. 5 is a diagram illustrating communication protocols between the mobile communication terminal and the controller in the robot control system according to the embodiment of the present disclosure.

The base member 12 is connected to the controller 11 in a wired-communication-enabled manner through the teaching operation device cable 33. When the software update processing is performed on the controller 11, the mobile communication terminal 13 in which the downloaded updating control software is stored is attached to the base member 12, and the mobile communication terminal 13 is connected to the base member 12 through a wired communication. In other words, when the software update processing is performed on the controller 11, the mobile communication terminal 13 is connected to the controller 11 in a wired-communication-enabled manner through the base member 12.

While communication protocols between the mobile communication terminal 13 and the controller 11, the communication protocols being used in the update processing of the control software of the controller 11, are, for example, FTP and TFTP, other communication protocols may be used. For example, communication protocols such as SMTP, SMB, STP, MTP, SCP, SFTP, and FTPS may be used. As an example, a case of using FTP and TFTP as the communication protocols will be described below. The controller 11 is provided with FTP client software and TFTP client software. The mobile communication terminal 13 functions as an FTP server and a TFTP server.

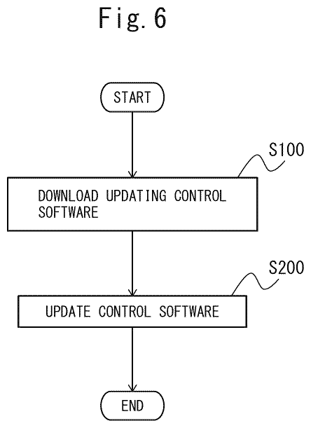

FIG. 6 is a flowchart illustrating an overall flow of the update processing of the control software of the controller in the robot control system according to the embodiment of the present disclosure.

In step S100, a worker removes the mobile communication terminal 13 from the base member 12 and releases the wired communication between the mobile communication terminal 13 and the base member 12 by removing the terminal cable 23 between the mobile communication terminal 13 and the base member 12. Then, the worker brings the mobile communication terminal 13 to an environment where Internet access is enabled and, for example, connects the mobile communication terminal 13 to the external server 3 through Wi-Fi (registered trademark). Then, the worker manually operates the mobile communication terminal 13 in such a way that updating control software is downloaded from the external server 3 to the mobile communication terminal 13.

In step S200, the worker attaches the mobile communication terminal 13 to the base member 12 and causes the mobile communication terminal 13 and the base member 12 to be in a wired-communication-enabled state by attaching the terminal cable 23 between the mobile communication terminal 13 and the base member 12. Then, the worker operates the mobile communication terminal 13 in such a way as to update the control software of the controller 11 with the updating control software stored in the mobile communication terminal 13.

In the robot control system 100, a computer program for causing a computer to execute the update processing of the control software of the controller 11 includes a download step and an update step. A computer program executing the download step operates when the mobile communication terminal 13 is removed from the base member 12 and the wired communication between the mobile communication terminal 13 and the base member 12 is released. The computer program executing the download step is specified to download updating control software from the external server 3 being an external device to the mobile communication terminal 13. The computer program executing the download step is installed on the mobile communication terminal 13 and, for example, includes FTP client software. A computer program executing the update step operates when the mobile communication terminal 13 is attached to the base member 12 and the mobile communication terminal 13 is connected to the base member 12 through a wired communication. The computer program executing the update step is specified in such a way as to update the control software of the controller 11 with the updating control software stored in the mobile communication terminal 13. The computer program executing the update step is installed on the mobile communication terminal 13 and the controller 11; and the controller 11 is provided with FTP client software and TFTP client software, and the mobile communication terminal 13 is provided with FTP server software and TFTP server software.

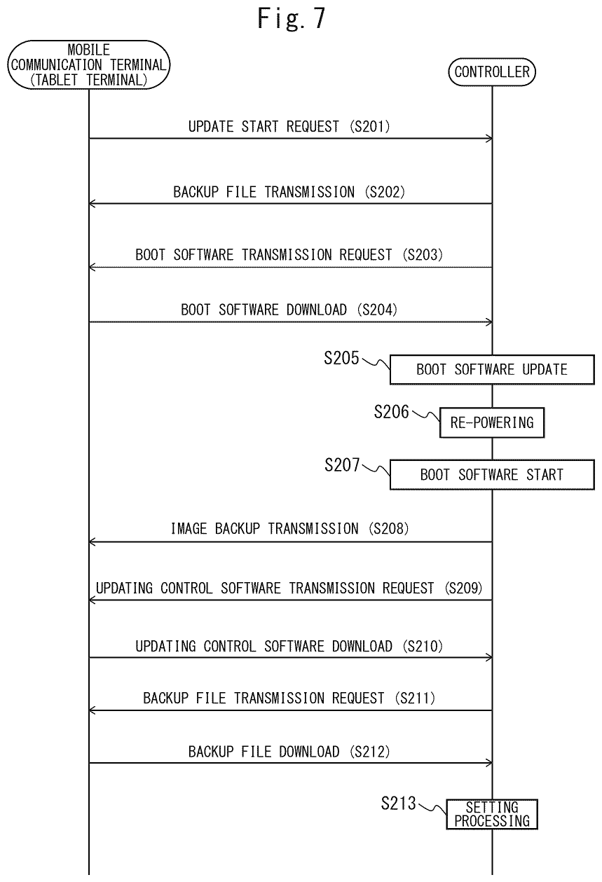

FIG. 7 is a flowchart illustrating a detailed operation flow of the update processing of the control software of the controller in the robot control system according to the embodiment of the present disclosure.

An example of an old version of the control software being already installed on the controller 11 and updating the control software with updating control software downloaded to the mobile communication terminal 13 (i.e., a new version of the control software) will be described.

A worker attaches the mobile communication terminal 13 in which the updating control software is stored to the base member 12 and causes the mobile communication terminal 13 and the base member 12 to be in a wired-communication-enabled state by attaching the terminal cable 23 between the mobile communication terminal 13 and the base member 12. Then, in an update start request step S201, the worker operates the mobile communication terminal 13 in such a way as to send an update start request from the mobile communication terminal 13 to the controller 11. For example, the update start request is made by the mobile communication terminal 13 by requesting a web server in the controller 11 to display a specific address; however, the request may be made by another method.

Next, in a backup file transmission step S202, the controller 11 transmits a backup file of the controller 11 from the controller 11 to the mobile communication terminal 13 by an FTP client included in the already-installed old version of the control program. For example, various setting parameters of the controller 11 are specified in the backup file. In order to avoid the setting parameters of the controller 11 being overwritten and erased by the update processing of the control software of the controller 11, the backup file is temporarily saved in the mobile communication terminal 13 in the backup file transmission step S202. A USB memory may be connected to the mobile communication terminal 13, and the backup file stored in the mobile communication terminal 13 may be written into the USB memory.

Next, in a boot software transmission request step S203, the controller 11 transmits a boot software transmission request of the controller 11 from the controller 11 to the mobile communication terminal 13 by the FTP client included in the already-installed old version of the control program.

Next, in a boot software download step S204, the controller 11 downloads new boot software from the mobile communication terminal 13 to the controller 11 by the FTP client included in the already-installed old version of the control program. TFTP client software is included in the new boot software.

Next, in a boot software update step S205, already-existing old boot software is deleted from the controller 11, and the new boot software downloaded in the boot software download step S204 is installed on the controller 11.

Next, in a re-powering step S206, the worker temporarily turns off the power to the controller 11 and then turns on the power again.

Next, in a boot software start step S207, the new boot software is started in the controller 11.

Next, in an image backup transmission step S208, the controller 11 transmits an image backup of the controller 11 from the controller 11 to the mobile communication terminal 13 by a TFTP client included in the new boot software. The image backup of the controller 11 is a copy of the old version of the control software (including a core file, optional files, and setting parameters) installed in the controller 11 for enabling restoration to the state before the software update processing. When the software update processing fails, the controller 11 can be restored to the state before the software update processing by using the image backup stored in the mobile communication terminal 13. A USB memory may be connected to the mobile communication terminal 13, and the image backup stored in the mobile communication terminal 13 may be written into the USB memory.

Next, in an updating control software transmission request step S209, the controller 11 transmits an updating control software transmission request from the controller 11 to the mobile communication terminal 13 by the TFTP client included in the new boot software.

Next, in an updating control software download step S210, the controller 11 downloads the updating control software from the mobile communication terminal 13 to the controller 11 by the FTP client and the TFTP client. The updating control software in the updating control software download step S210 is downloaded in two parts. First, the controller 11 downloads a first part of the updating control software from the mobile communication terminal 13 to the controller 11 by the TFTP client included in the new boot software. A core file and part of optional files of the updating control software, and FTP client software are included in the downloaded first part of the updating control software. Initial values of setting parameters of the controller 11 are also specified in the core file of the updating control software. Further, the initial values of the setting parameters of the controller 11 are also specified in the optional files. Further, the initial values of the setting parameters of the controller 11 are also specified in the FTP client software. Next, the controller 11 downloads a second part of the updating control software from the mobile communication terminal 13 to the controller 11 by the FTP client included in the downloaded first part of the updating control software. The remaining optional files of the updating control software are included in the downloaded second part of the updating control software.

Next, in a backup file transmission request step S211, the controller 11 transmits a backup file transmission request from the controller 11 to the mobile communication terminal 13 by the FTP client included in the downloaded first part of the updating control software.

Next, in a backup file download step S212, the controller 11 downloads the backup file from the mobile communication terminal 13 to the controller 11 by the FTP client included in the downloaded first part of the updating control software. The backup file downloaded in the backup file download step S212 is a file temporarily saved into the mobile communication terminal 13 in the backup file transmission step S202.

Next, in a setting step S213, the setting parameters of the control software of the controller 11 are returned to the state before the software update processing, based on the backup file downloaded in the backup file download step S212. Since initial values are set as setting parameters in the core file, the optional files, and the FTP client software in the updating control software downloaded in the updating control software download step S210, the setting parameters of the control software of the controller 11 are returned to the state before the software update processing by overwriting the initial values with the setting parameters specified in the backup file.

According to the embodiment described with reference to FIG. 5 to FIG. 7, the controller 11 is provided with FTP client software and TFTP client software, and the mobile communication terminal 13 functions as an FTP server and a TFTP server. As a modified example of the embodiment, a client-server relation may be reversed in such a way that the mobile communication terminal 13 is provided with FTP client software and TFTP client software, and the controller 11 functions as an FTP server and a TFTP server. The descriptions related to “download” of boot software, updating control software, and a backup file from the mobile communication terminal 13 to the controller 11 in FIG. 7 are applied by being read as “upload” in this modified example.

As described above, the embodiment of the present disclosure can provide a robot control system and a computer program that can easily update control software of the controller 11.

While the present disclosure has been described in detail, the present disclosure is not limited to each embodiment described above. Various additions, substitutions, changes, partial deletions, etc. may be made to the embodiments without departing from the spirit of the present disclosure or without departing from the scope of the present disclosure derived from the contents described in the claims and the equivalents thereof. Further, the embodiments may be implemented in combination. For example, the operation order or processing order is described as an example in the aforementioned embodiments and is not limited thereto Further, the above holds when a numerical value or a mathematical expression is used in the description of the aforementioned embodiments.

The following Supplementary Notes are further disclosed with regard to the aforementioned embodiments and the modified examples thereof

### Supplementary Note 1

A robot control system 100 including:
a controller 11 of a robot 2;
a base member 12 connected to the controller 11 through a wired communication; and
a mobile communication terminal 13 being attachable and detachable to and from the base member 12, being able to wirelessly communicate with an external device, and instructing the controller 11 about a motion of the robot 2, based on a teaching operation content, when being attached to the base member 12 and being connected to the base member 12 through a wired communication, wherein
updating control software is downloaded from an external server 3 being the external device to the mobile communication terminal 13 when the mobile communication terminal 13 is removed from the base member 12 and a wired communication with the base member 12 is released, and
control software of the controller 11 is updated with the downloaded updating control software when the mobile communication terminal 13 is attached to the base member 12 and is connected to the base member 12 through a wired communication.

### Supplementary Note 2

The robot control system 100 according to Supplementary Note 1, wherein
the updating control software is downloaded from the external server 3 to the mobile communication terminal 13 through a wireless communication when the mobile communication terminal 13 is removed from the base member 12 and a wired communication with the base member 12 is released.

### Supplementary Note 3

The robot control system 100 according to Supplementary Note 1, wherein
the updating control software is downloaded from the external server 3 to the mobile communication terminal 13 through a wired communication when the mobile communication terminal 13 is removed from the base member 12 and a wired communication with the base member 12 is released.

### Supplementary Note 4

The robot control system 100 according to any one of Supplementary Notes 1 to 3, wherein
the base member 12 includes:
   an enable switch 31 permitting control of a motion of the robot 2 by the controller 11 while being depressed and prohibiting control of a motion of the robot 2 by the controller 11 by release of depression;
   an emergency stop button 32 for instructing the controller 11 to cause the robot 2 to make an emergency stop; and
   an attachment base 30 for attachably and detachably attaching the mobile communication terminal 13.

### Supplementary Note 5

The robot control system 100 according to any one of Supplementary Notes 1 to 4, wherein
communication protocols between the mobile communication terminal 13 and the controller 11, the communication protocols being used for updating control software of the controller 11, are FTP and TFTP.

### Supplementary Note 6

A computer program for causing a computer to execute update processing of control software of a controller 11 of a robot 2 in a robot control system 100 including: a base member 12 connected to the controller 11; and a mobile communication terminal 13 being attachable and detachable to and from the base member 12 and instructing the controller 11 about a motion of the robot 2, based on a teaching operation content, the computer program comprising:
a download step of downloading updating control software from an external server 3 being an external device to the mobile communication terminal 13 when the mobile communication terminal 13 is removed from the base member 12 and a wired communication with the base member 12 is released; and
an update step of updating control software of the controller 11 with the updating control software downloaded in the download step when the mobile communication terminal 13 is attached to the base member 12 and is connected to the base member through a wired communication.

### Supplementary Note 7

The computer program for causing the computer to execute the update processing according to Supplementary Note 6, wherein,
in the update step, communication protocols between the mobile communication terminal 13 and the controller 11, the communication protocols being used for updating control software of the controller 11, are FTP and TFTP.

### Supplementary Note 8

The computer program for causing the computer to execute the update processing according to Supplementary Note 7, wherein
the controller 11 is provided with FTP client software and TFTP client software, and the mobile communication terminal 13 functions as an FTP server and a TFTP server.

### Supplementary Note 9

The computer program for causing the computer to execute the update processing according to Supplementary Note 8, wherein
the update step includes:
   a boot software download step of downloading new boot software from the mobile communication terminal 13 to the controller 11 by an FTP client;
   a boot software update step of, after the boot software download step is executed, deleting old boot software already existing in the controller 11 and installing the new boot software downloaded in the boot software download step on the controller 11;
   a boot software start step of starting the new boot software in the controller 11 after the boot software update step is executed and power to the controller 11 is turned on again;
   an updating control software download step of downloading the updating control software from the mobile communication terminal 13 to the controller 11 by an FTP client and a TFTP client after the boot software start step is executed; and
   a setting step of returning a setting parameter of control software of the controller 11 to a state before execution of the update step.

### Supplementary Note 10

The computer program for causing the computer to execute the update processing according to Supplementary Note 9, wherein
the update step includes:
   an update start request step of transmitting an update start request from the mobile communication terminal 13 to the controller 11;
   a backup file transmission step of transmitting a backup file of the controller 11 from the controller 11 to the mobile communication terminal 13 by an FTP client after the update start request step is executed; and
   a boot software transmission request step of transmitting a boot software transmission request from the controller 11 to the mobile communication terminal 13 by an FTP client after the backup file transmission step is executed, and
the boot software download step is executed after the boot software transmission request step is executed.

### Supplementary Note 11

The computer program for causing the computer to execute the update processing according to Supplementary Note 10, wherein
the update step includes:
   an image backup transmission step of transmitting an image backup of the controller 11 from the controller 11 to the mobile communication terminal 13 by a TFTP client included in the new boot software after the boot software start step is executed; and
   an updating control software transmission request step of transmitting an updating control software transmission request from the controller 11 to the mobile communication terminal 13 by a TFTP client included in the new boot software after the image backup transmission step is executed, and
the updating control software download step is executed after the updating control software transmission request step is executed.

### Supplementary Note 12

The computer program for causing the computer to execute the update processing according to Supplementary Note 11, wherein
the update step includes:
   a backup file transmission request step of transmitting a backup file transmission request from the controller 11 to the mobile communication terminal 13 by an FTP client after the updating control software download step is executed; and
   a backup file download step of downloading a backup file from the mobile communication terminal 13 to the controller 11 by an FTP client after the backup file transmission request step is executed, and,
in the setting step, a setting parameter of control software of the controller 11 is returned to a state before execution of the update step, based on the backup file downloaded in the backup file download step.

### Supplementary Note 13

An update processing method for control software of a controller 11 of a robot 2 in a robot control system 100 including: a base member 12 connected to the controller 11; and a mobile communication terminal 13 being attachable and detachable to and from the base member 12 and instructing the controller 11 about a motion of the robot 2, based on a teaching operation content, the update processing method including:
a download step of downloading an updating control software from an external server 3 being an external device to the mobile communication terminal 13 when the mobile communication terminal 13 is removed from the base member 12 and a wired communication with the base member 12 is released; and
an update step of updating control software of the controller 11 with the updating control software downloaded in the download step when the mobile communication terminal 13 is attached to the base member 12 and is connected to the base member through a wired communication.

### Supplementary Note 14

A controller 11 equipped with control software for controlling an industrial machine, the controller 11 including:
at least one memory; and
at least one processor, wherein
the at least one processor
   accepts a connection to a base member 12,
   accepts a connection to a mobile communication terminal 13 attachable and detachable to and from the base member 12 or a connection to the mobile communication terminal 13 through a connection to the base member 12,
   acquires updating control software from the mobile communication terminal 13 and stores the updating control software into the at least one memory after accepting connections to the base member 12 and the mobile communication terminal 13, and
   updates the control software with the updating control software stored in the at least one memory.

### Supplementary Note 15

The controller 11 according to Supplementary Note 14, wherein
communication protocols between the mobile communication terminal 13 and the controller 11, the communication protocols being used for updating the control software, are FTP and TFTP.

### Supplementary Note 16

The controller 11 according to Supplementary Note 15, wherein
the controller 11 is provided with FTP client software and TFTP client software, and the mobile communication terminal 13 functions as an FTP server and a TFTP server.

### REFERENCE SIGNS LIST

1 Teaching operation device
2 Robot
3 External server
4 Internet line
5 Router
6 USB cable
11 Controller
12 Base member
13 Mobile communication terminal
23 Terminal cable
30 Attachment base
31 Enable switch
32 Emergency stop button
33 Teaching operation device cable
41 Robot cable
100 Robot control system

1. A robot control system comprising:
a controller of a robot;
a base member connected to the controller through a wired communication; and
a mobile communication terminal being attachable and detachable to and from the base member, being able to wirelessly communicate with an external device, and instructing the controller about a motion of the robot, based on a teaching operation content, when being attached to the base member and being connected to the base member through a wired communication, wherein
updating control software is downloaded from an external server being the external device to the mobile communication terminal when the mobile communication terminal is removed from the base member and a wired communication with the base member is released, and
control software of the controller is updated with the downloaded updating control software when the mobile communication terminal is attached to the base member and is connected to the base member through a wired communication.

2. The robot control system according to claim 1, wherein
the updating control software is downloaded from the external server to the mobile communication terminal through a wireless communication when the mobile communication terminal is removed from the base member and a wired communication with the base member is released.

3. The robot control system according to claim 1, wherein
the updating control software is downloaded from the external server to the mobile communication terminal through a wired communication when the mobile communication terminal is removed from the base member and a wired communication with the base member is released.

4. The robot control system according to claim 1, wherein
the base member includes:
an enable switch permitting control of a motion of the robot by the controller while being depressed and prohibiting control of a motion of the robot by the controller by release of depression;
an emergency stop button for instructing the controller to cause the robot to make an emergency stop; and
an attachment base for attachably and detachably attaching the mobile communication terminal.

5. The robot control system according to claim 1, wherein
communication protocols between the mobile communication terminal and the controller, the communication protocols being used for updating control software of the controller, are FTP and TFTP.

6. A non-transitory computer readable medium storing a computer program for causing a computer to execute update processing of control software of a controller of a robot in a robot control system including: a base member connected to the controller; and a mobile communication terminal being attachable and detachable to and from the base member and instructing the controller about a motion of the robot, based on a teaching operation content, the computer program comprising:
a download step of downloading updating control software from an external server being an external device to the mobile communication terminal when the mobile communication terminal is removed from the base member and a wired communication with the base member is released; and
an update step of updating control software of the controller with the updating control software downloaded in the download step when the mobile communication terminal is attached to the base member and is connected to the base member through a wired communication.

7. The non-transitory computer readable medium storing the computer program for causing the computer to execute the update processing according to claim 6, wherein,
in the update step, communication protocols between the mobile communication terminal and the controller, the communication protocols being used for updating control software of the controller, are FTP and TFTP.

8. The non-transitory computer readable medium storing the computer program for causing the computer to execute the update processing according to claim 7, wherein
the controller is provided with FTP client software and TFTP client software, and the mobile communication terminal functions as an FTP server and a TFTP server.

9. The non-transitory computer readable medium storing the computer program for causing the computer to execute the update processing according to claim 8, wherein
the update step includes:
a boot software download step of downloading new boot software from the mobile communication terminal to the controller by an FTP client;
a boot software update step of, after the boot software download step is executed, deleting old boot software already existing in the controller and installing the new boot software downloaded in the boot software download step on the controller;
a boot software start step of starting the new boot software in the controller after the boot software update step is executed and power to the controller is turned on again;
an updating control software download step of downloading the updating control software from the mobile communication terminal to the controller by an FTP client and a TFTP client after the boot software start step is executed; and
a setting step of returning a setting parameter of control software of the controller to a state before execution of the update step.

10. The non-transitory computer readable medium storing the computer program for causing the computer to execute the update processing according to claim 9, wherein
the update step includes:
an update start request step of transmitting an update start request from the mobile communication terminal to the controller;
a backup file transmission step of transmitting a backup file of the controller from the controller to the mobile communication terminal by an FTP client after the update start request step is executed; and
a boot software transmission request step of transmitting a boot software transmission request from the controller to the mobile communication terminal by an FTP client after the backup file transmission step is executed, and
the boot software download step is executed after the boot software transmission request step is executed.

11. The non-transitory computer readable medium storing the computer program for causing the computer to execute the update processing according to claim 10, wherein
the update step includes:
an image backup transmission step of transmitting an image backup of the controller from the controller to the mobile communication terminal by a TFTP client included in the new boot software after the boot software start step is executed; and
an updating control software transmission request step of transmitting an updating control software transmission request from the controller to the mobile communication terminal by a TFTP client included in the new boot software after the image backup transmission step is executed, and
the updating control software download step is executed after the updating control software transmission request step is executed.

12. The non-transitory computer readable medium storing the computer program for causing the computer to execute the update processing according to claim 11, wherein
the update step includes:
a backup file transmission request step of transmitting a backup file transmission request from the controller to the mobile communication terminal by an FTP client after the updating control software download step is executed; and
a backup file download step of downloading a backup file from the mobile communication terminal to the controller by an FTP client after the backup file transmission request step is executed, and,
in the setting step, a setting parameter of control software of the controller is returned to a state before execution of the update step, based on the backup file downloaded in the backup file download step.

13. An update processing method for control software of a controller of a robot in a robot control system including: a base member connected to the controller; and a mobile communication terminal being attachable and detachable to and from the base member and instructing the controller about a motion of the robot, based on a teaching operation content, the update processing method comprising:
a download step of downloading updating control software from an external server being an external device to the mobile communication terminal when the mobile communication terminal is removed from the base member and a wired communication with the base member is released; and
an update step of updating control software of the controller with the updating control software downloaded in the download step when the mobile communication terminal is attached to the base member and is connected to the base member through a wired communication.

14. A controller equipped with control software for controlling an industrial machine, the controller comprising:
at least one memory; and
at least one processor, wherein
the at least one processor
accepts a connection to a base member,
accepts a connection to a mobile communication terminal attachable and detachable to and from the base member or a connection to the mobile communication terminal through a connection to the base member,
acquires updating control software from the mobile communication terminal and stores the updating control software into the at least one memory after accepting connections to the base member and the mobile communication terminal, and
updates the control software with the updating control software stored in the at least one memory.

15. The controller according to claim 14, wherein
communication protocols between the mobile communication terminal and the controller, the communication protocols being used for updating the control software, are FTP and TFTP.

16. The controller according to claim 15, wherein
the controller is provided with FTP client software and TFTP client software, and the mobile communication terminal functions as an FTP server and a TFTP server.
